(19) United States
(12) Patent Application Publication
(10) Pub. No.: US 2025/0166106 A1
(43) Pub. Date: May 22, 2025

(54) MOTOR CARRIER AND DRIVER SAFETY SCORE PREDICTION SYSTEMS AND METHODS

(71) Applicants: Oleksandra Dobrovolska, Chicago, IL (US); Demna Sakhltkhutsishvili, Hanover Park, IL (US); Iraklijs Sahlthucisvili, Wheeling, IL (US)

(72) Inventors: Oleksandra Dobrovolska, Chicago, IL (US); Demna Sakhltkhutsishvili, Hanover Park, IL (US); Iraklijs Sahlthucisvili, Wheeling, IL (US)

(21) Appl. No.: 18/745,984

(22) Filed: Jun. 17, 2024

Related U.S. Application Data
(60) Provisional application No. 63/508,877, filed on Jun. 16, 2023.

(51) Int. Cl. G06Q 50/40

(52) U.S. Cl. CPC G06Q 50/40

(57) ABSTRACT

Computer-implemented motor carrier and driver safety score prediction systems and methods are described.

### RELATED APPLICATIONS

This application claims the benefit of U.S. Application No. 63/508,877, entitled “Motor Carrier and Driver Safety Score Prediction Systems and Methods,” filed on Jun. 16, 2023, which is incorporated herein by reference in its entirety.

### FIELD

Some implementations are generally related to computerized transportation safety management systems, and, more particularly related to motor carrier and driver safety score prediction systems and methods.

### BACKGROUND

Transportation agencies, such as the Federal Motor Carrier Safety Administration (FMCSA), promulgate rules, regulations and best practices for transportation safety as it pertains to carriers and drivers. For example, the FMCSA has developed a safety monitoring and compliance program called CSA, which stands for Compliance, Safety, and Accountability. The CSA program creates a safety score for motor carriers and drivers that can be used to prioritize motor carriers and drivers for interventions by the FMCSA such as warning letters and investigations. CSA safety scores can also be used by insurance companies, carriers, etc. to gauge the safety performance of a motor carrier or driver. CSA safety scores are generated regularly (e.g., once a month), but only reflect past events. A need may exist for a computerized system to utilize public and private data to predict a future safety score.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method comprising obtaining published data corresponding to one or more safety score categories and applying a safety methodology to the published data to generate a published data score. The method can also include obtaining published data corresponding to the one or more safety score categories and applying a safety methodology to the unpublished data to generate an unpublished data score. The method can further include combining the published data score and the unpublished data score and generating a percentile prediction from the combined published data score and unpublished data score.

The method can also include obtaining simulated data corresponding to the one or more safety score categories. The method can further include generating a simulated percentile prediction based on the simulated data.

In some implementations, the safety methodology includes the FMCSA SMS methodology. In some implementations, the one or more safety score categories include unsafe driving, crash indicator, hours of service compliance, vehicle maintenance, controlled substances and alcohol, hazardous materials compliance, and driver fitness.

The method can further include causing to be displayed a safety score visualization user interface including: elements for selecting one or more of the safety score categories; a graphical display element having a portion showing an actual safety score value corresponding to a selected one or more of the safety score categories and a portion showing a predicted safety score value corresponding to the selected one or more of the safety score categories; and an element for selecting a time period for displaying the actual safety score and the predicted safety score.

In some implementations, obtaining simulated data corresponding to the one or more safety score categories includes displaying a safety score user interface configured to accept one or more simulated data values and an element to recalculate safety scores, and when the element to recalculate safety scores is selected, causing the predicted safety scores to be recalculated based on the one or more simulated data values.

### BRIEF DESCRIPTION OF THE DRAWINGS

FIG. 1 is a block diagram of an example system and a network environment which may be used for one or more implementations described herein.

FIG. 2 is a block diagram of an example safety score prediction system in accordance with some implementations.

FIG. 3 is a flowchart showing an example method of safety score prediction in accordance with some implementations.

FIG. 4 is a block diagram of an example computing device which may be used for one or more implementations described herein.

FIG. 5 is a diagram of an example of an improved user interface showing unsafe driving scores in accordance with some implementations.

FIG. 6 is diagram of an example improved user interface showing crash indicator safety scores in accordance with some implementations.

FIG. 7 is a diagram of an example of an improved user interface showing hours of service safety scores in accordance with some implementations.

FIG. 8 is a diagram of an example of an improved user interface showing vehicle maintenance safety scores in accordance with some implementations.

FIG. 9 is a diagram of an example of an improved user interface showing in accordance with some implementations.

FIG. 10 is a diagram of an example improved user interface showing seven FMCSA BASIC safety scores in accordance with some implementations.

FIG. 11 is a diagram of an example of an improved user interface showing a single BASIC in accordance with some implementations.

FIG. 12 is a diagram of an example of an improved user interface showing crash indicator safety scores in accordance with some implementations.

FIG. 13 is a diagram of an example of an improved user interface showing hours of service safety scores in accordance with some implementations.

FIG. 14 is a diagram of an example of an improved user interface showing vehicle maintenance safety scores in accordance with some implementations.

FIG. 15 is a diagram of an example of an improved user interface showing drug/alcohol safety scores in accordance with some implementations.

FIG. 16 is a diagram of an example of an improved user interface showing seven FMCSA BASIC safety scores in accordance with some implementations.

FIG. 17 is a diagram of an example safety score calculation history. The calculator history interface shows the calculated values for the seven BASICs for a plurality of dates. The example safety score calculation history user interface includes an element to add data for predicting scores.

FIG. 18 is a diagram showing an example expanded safety score calculation interface in which the element for adding data for predicting scores was selected.

FIGS. 19-20 are diagrams showing additional details supporting safety score calculation in accordance with some implementations.

FIGS. 21-22 are diagrams showing additional are diagrams showing additional details supporting safety score calculation in accordance with some implementations.

### DETAILED DESCRIPTION

Some implementations include motor carrier and driver safety score prediction methods and systems. Some implementations can include simplifying the process of reading existing data from the FMCSA. Some implementations can include compiling data for managerial use. Some implementations can include providing a tendency of safety scores and effectiveness of a Safety Management Plan (SMP).

FMCSA's Safety Measurement System (SMS) determines an overall Behavior Analysis and Safety Improvement Category (BASIC) status for each motor carrier based upon roadside inspection results that are reflected as a percentile rank and/or prior investigation violations. This information can be seen by logging into the SMS Website (https://ai.fmcsa.dot.gov/sms/). Once logged into the SMS Website, motor carriers with safety compliance problems in a BASIC will see a warning symbol in that BASIC. You can also view the records of a company's roadside inspections and request a review of those records believed to be inaccurate through DataQs. Violations of the regulations related to the HM Compliance BASIC raise the percentile rank, which indicates lower safety compliance and may lead to warning letters or investigations. However, the FMCSA SMS does not provide any predictive analysis or information to users or any “what if” scenario analysis and SMS percentile change estimation, the FMCSA SMS only provides an indication of where a carrier currently stands in terms of each BASIC within the SMS. As discussed above, having a prediction of a future SMS BASIC percentile ranking or change over time can help a carrier make more informed planning and operational decisions.

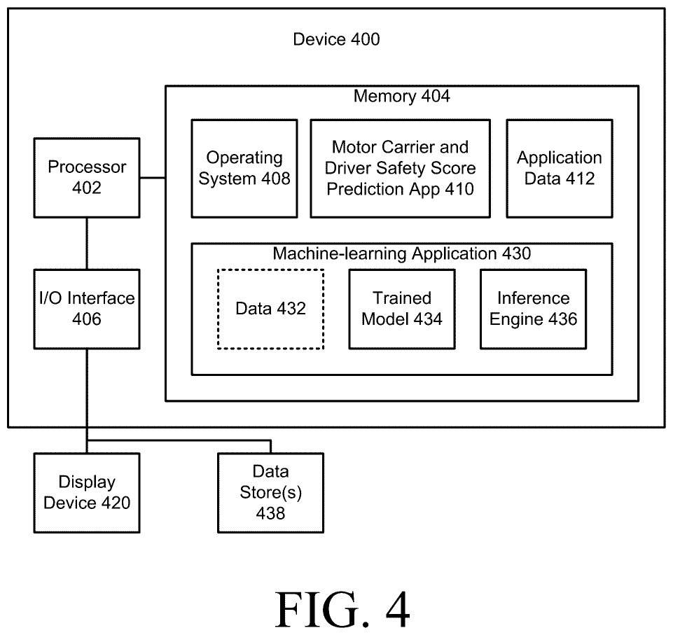

When performing motor carrier and driver safety score prediction functions, it may be helpful for a system to suggest changes to improve future safety scores and/or to make predictions about motor carrier and driver safety scores. To make predictions or suggestions, a probabilistic model (or other model as described below in conjunction with FIG. 4) can be used to make an inference (or prediction) about aspects of motor carrier and driver safety score. Accordingly, it may be helpful to make an inference regarding the probability that one or more safety program factors will affect safety score. Other aspects can be predicted or suggested as described below.

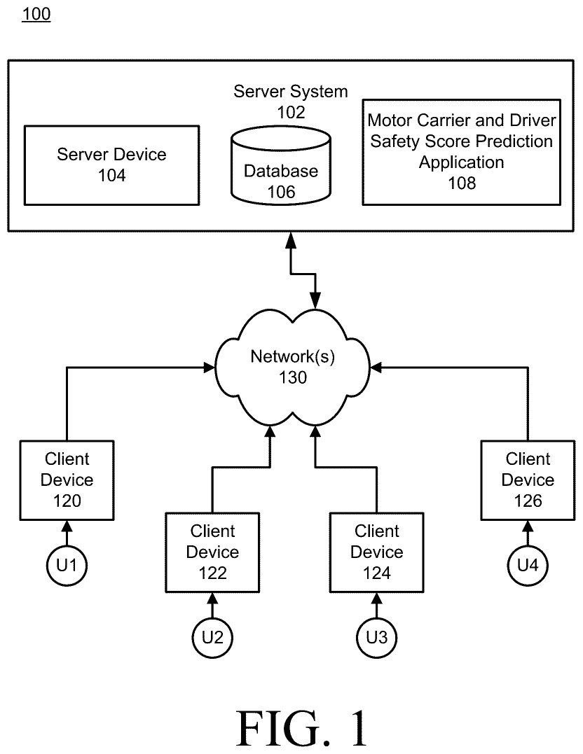

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and motor carrier and driver safety score prediction application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide motor carrier and driver safety score/percentile prediction functions as described herein.

Various implementations of features described herein can use any type of system and/or service. Any type of electronic device can make use of the features described herein. Some implementations can provide one or more features described herein on client or server devices disconnected from or intermittently connected to computer networks.

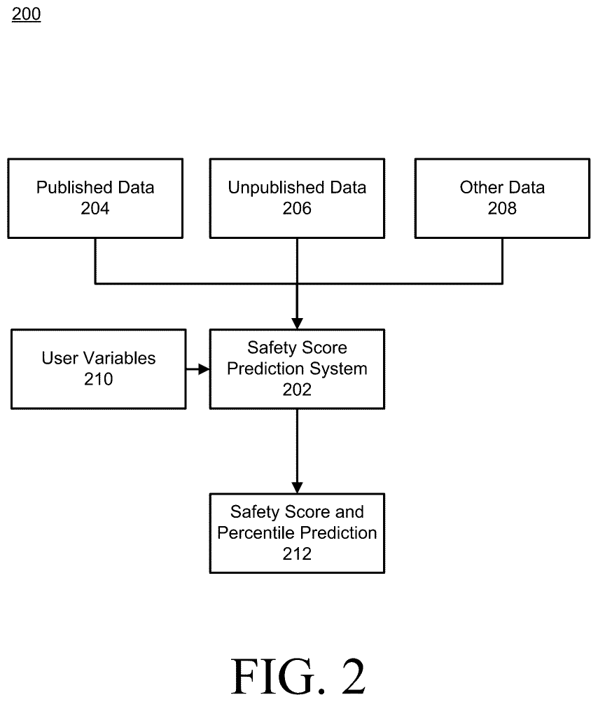

FIG. 2 is a block diagram of an example safety score prediction system 200 in accordance with some implementations. The system 200 includes a safety score prediction system 202. As input, the safety score prediction system 202 receives published data 204, unpublished data 206, and other data 208 (optional). For example, published data can include CSA monthly published data, which can include census data and SMS results, or other published private source or public source of information. Unpublished data can include FMCSA carrier portal data such as crash data, inspection list, and ISS score data or other unpublished data such as private data (e.g., company data), government entity, or other entity data. Other data 208 can optionally be used that is not included in the published 204 or unpublished data 206, for example data from external sources such as driver applicant information, driver background check information, driver medical information (when shared with permission), driver hiring patterns or trends (e.g., based on driver application and background information), etc. can be included as other input data 208

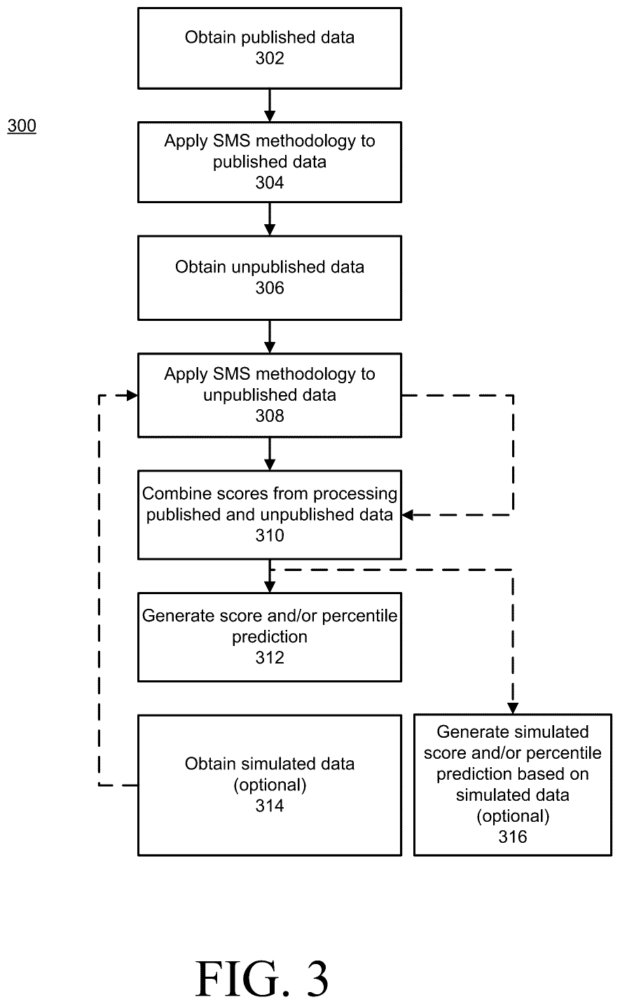

Also, user variables 210 (e.g., parameters a user wishes to evaluate for safety score prediction impact) can be provided to the safety score prediction system 202 as input. The safety score prediction system 202 processes the inputs and generates predicted future safety scores and potential percentile ranking 212 based on previous data by applying the SMS methodology. An example score prediction method is shown in FIG. 3 and described below.

FIG. 3 is a flowchart showing an example method 300 of safety score prediction in accordance with some implementations. Processing begins at 302 where published data is obtained. Published data can include CSA monthly published data, which can include census data and SMS results. Processing continues to 304.

At 304, the SMS methodology (e.g., as developed by FMCSA) or other similar methodology is applied to the published data. Processing continues to 306.

At 306, unpublished data is obtained. Unpublished data can include FMCSA carrier portal data such as crash data, inspection list, and ISS score data. Processing continues to 308.

At 308, the SMS methodology (e.g., as developed by FMCSA) is applied to the unpublished data. Processing continues to 310.

At 310, the scores from processing the published and unpublished data are combined. Processing continues to 312.

At 312, a safety score and/or percentile is generated. Steps 302-312 can be repeated as new data is received or based on other inputs as needed.

At 314, optionally insert simulated data into the model. Simulated data can include user variables or other changes to data (e.g., to explore impacts to the safety score from various events or changes). For example, a user could dispute data and if the disputed data is removed, or, a “what if” scenario could be performed such as driver receiving a ticket or getting into a crash. Processing continues to 316.

At 316, simulated predicted scores and/or percentiles are generated based on the simulated data by applying the steps at 308-312 to generate predicted scores based on the simulated data (as shown by dashed lines).

### Example Use Cases

### Example Use Case 1—Service for Individual Carrier Safety Managers

Permits user to see past/future tendencies of safety scores and what causes the changes.

Can be used to identify:
risk areas (Hours Of Service; Unsafe Driving; Vehicle Maintenance; Driver Fitness; etc.).
risk of intervention (audit) by the State or Federal DOT.
risk of losing safety score-based contracts or agreements.
risk of commercial insurance policy renewal or premium increment (Traditional Liability insurance markets).

See what potentially will be reported by the Central Analysis Bureau (CAB) report used by most adjusters (or other reporting) during insurance policy binding or renewal.

### Example Use Case 2—Service for the Commercial Insurance Companies; Insurance Agencies; Risk Purchasing Groups (RPGs)

Can be used to monitor the tendency of the safety scores and identify potential future risks, and to monitor score improvements or worsening in the future and the ability to see the causes.

### Example Use Case 3—Group/Captive Insurance Managers

This implementation can permit a user to see safety scores for feasibility or onboarding, including monitoring individual group members, the entire group, or all groups collectively.

Some implementations can include algorithms for other internal or external databases for various managerial uses to identify root causes for any obvious or potential risks and also accuracy of published or unpublished data.

Some implementations can include a “Comparing tool” for other existing reporting utilized by Insurance companies.

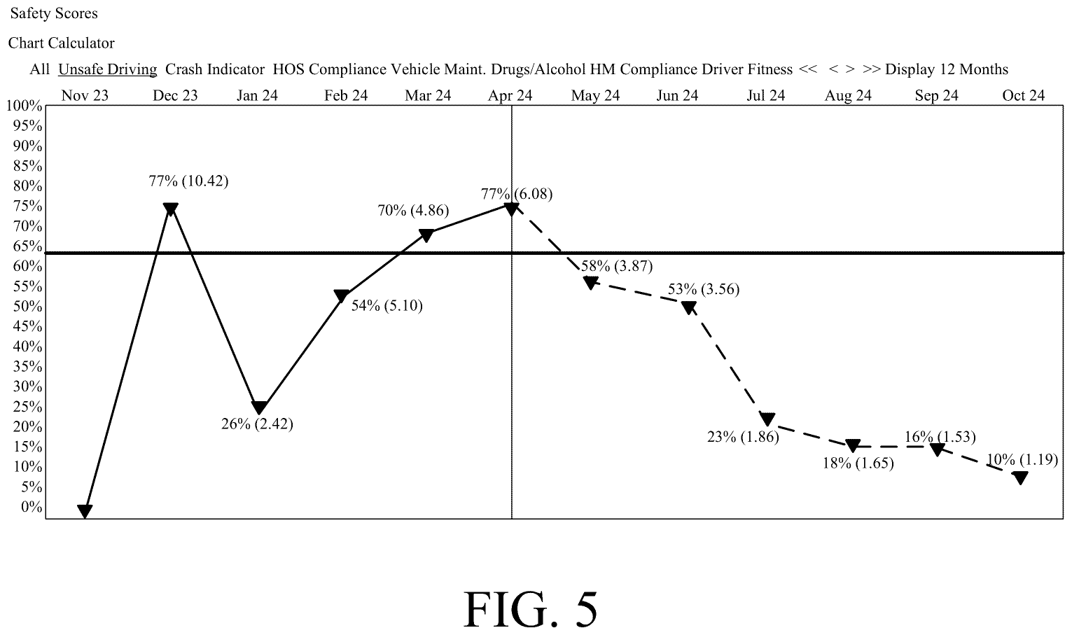

Some implementations can include an improved user interface that displays calculated SMS scores (or percentiles) based on actual data and predicted SMS scores over time in the future. The improved user interface can show the past actual and predicted future SMS scores for one or more FMCSA BASICS. For example, FIGS. 5-16 show examples of the improved user interface. The seven BASICs used by the Federal Motor Carrier Safety Administration (FMCSA) to calculate CSA scores are:
Unsafe Driving: Includes behaviors like speeding, texting, reckless driving, and improper lane changes
Crash Indicator: A history of crashes, including their frequency and severity
Hours of Service Compliance: Also known as Fatigued Driving
Vehicle Maintenance: Includes CFR Parts 393 and 396
Controlled Substances and Alcohol: Includes CFR Parts 382 and 392
Hazardous Materials Compliance: Also known as Cargo-Related
Driver Fitness: Includes CFR Parts 383 and 391

In the user interfaces diagrams of FIGS. 5-22 described below, the red line (or dashed horizontal line separating the two backgrounds) indicates a threshold level above which the FMCSA may determine that the safety score or percentile is not acceptable, and an alert may be raised. This level is typically either 60% or 85% depending on the BASIC.

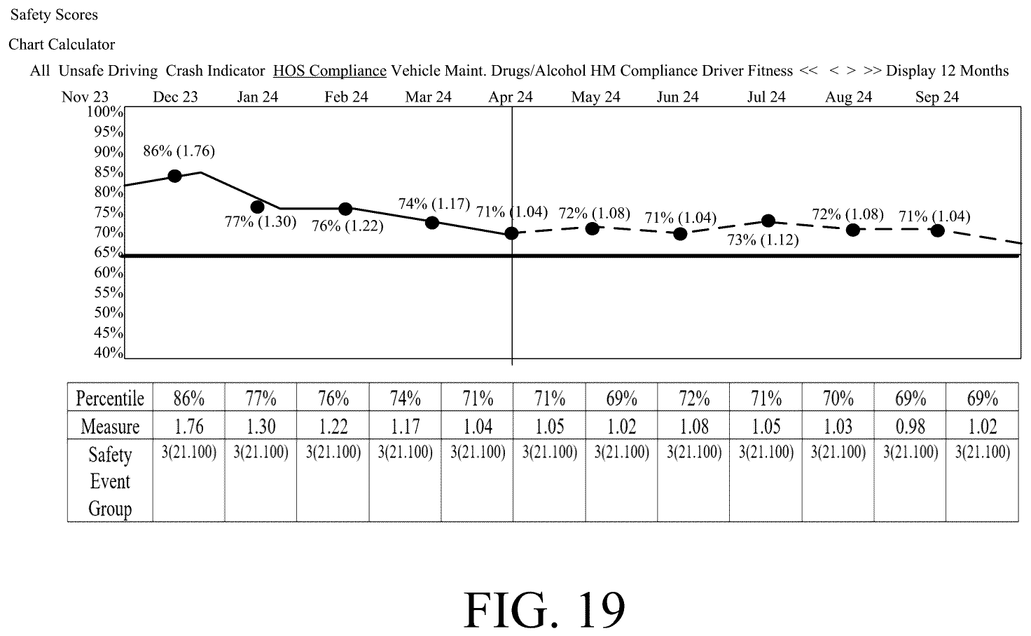

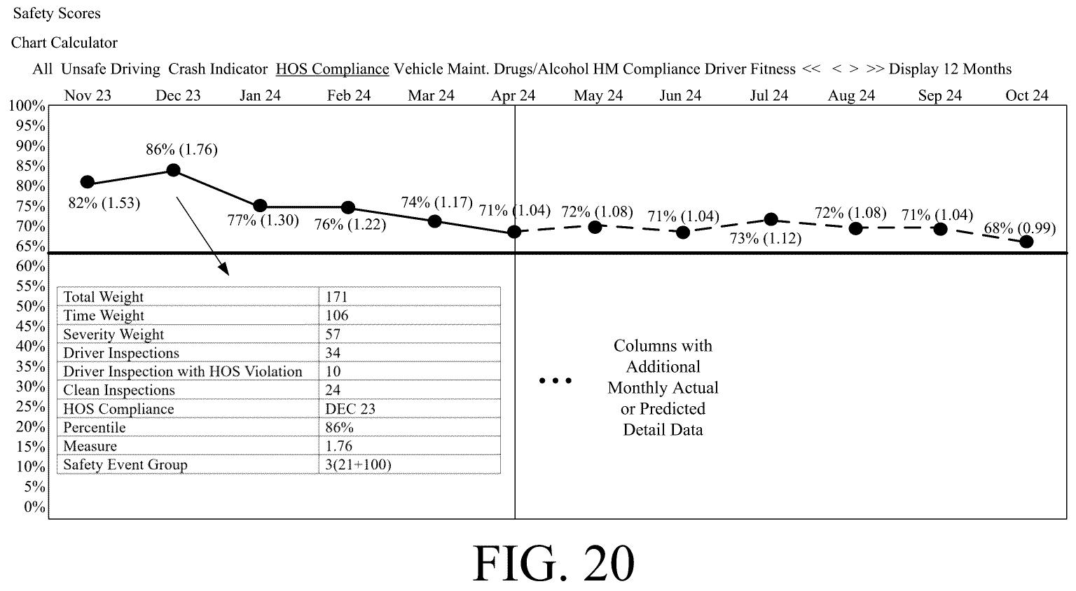

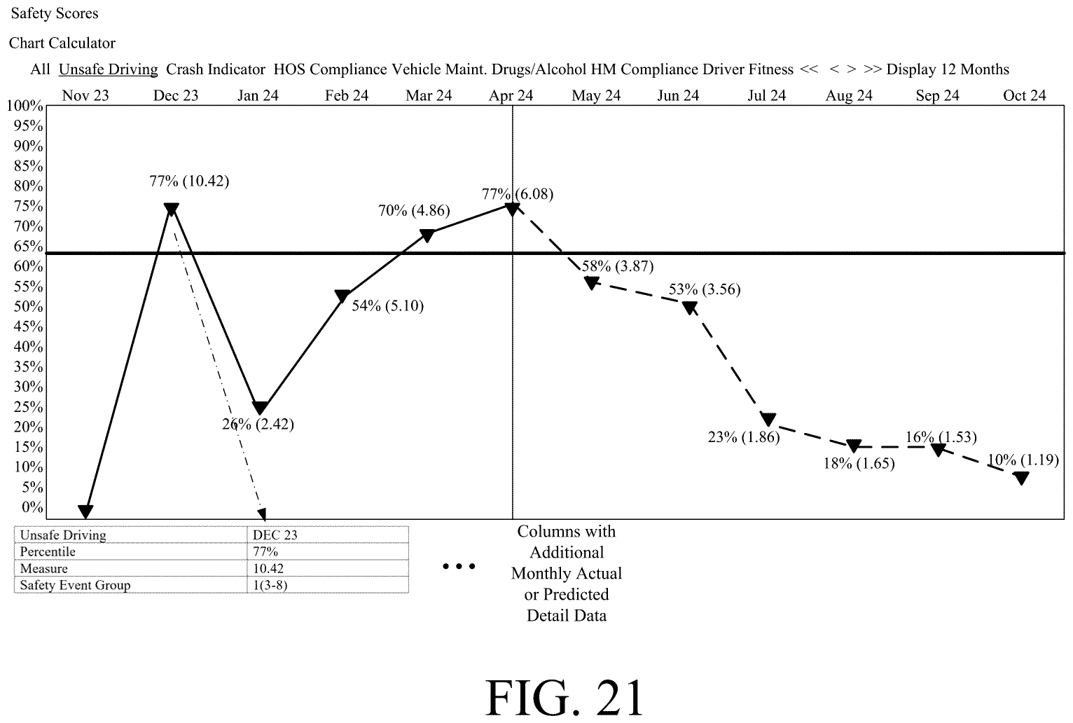

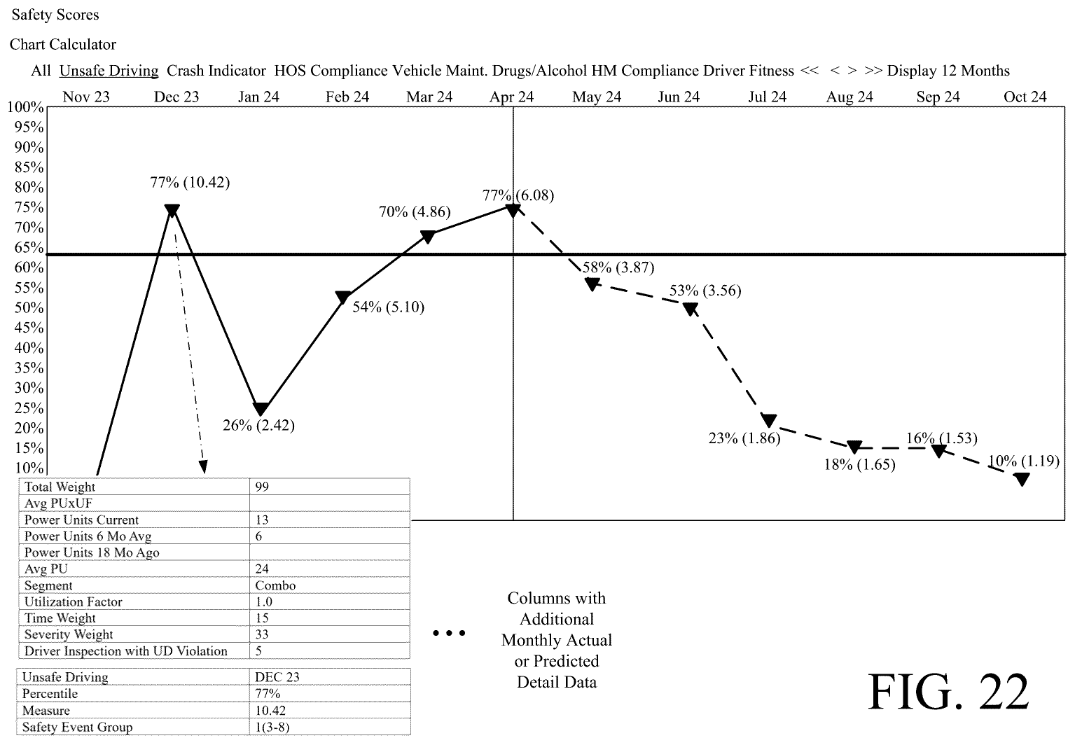

FIG. 5 is an example of an improved user interface showing 12 months of a single BASIC—unsafe driving scores—with 6 months of actual data and 6 months of predicted data. Within the improved user interface of FIG. 5 (and the others discussed below), a user can click on (or select) a datapoint or measure within the interface and display additional details. For example, FIGS. 19-20 are diagrams showing additional details supporting safety score calculation for BASICs other than Unsafe Driving and Crash Indicator, where FIG. 19 is what is displayed when a user clicks on a data point for details and FIG. 20 is what is displayed when a user clicks on a measure for more details. FIGS. 21-22 are diagrams showing example additional details supporting safety score calculations for the Unsafe Driving and Crash Indicator BASICs, where FIG. 20 is what is displayed when a user clicks on a data point for more details and FIG. 20 is what is displayed when a user clicks on a measure for more details.

In operation, a user can select one or more BASICs and can select a time range (e.g., 12 months or 24 months).

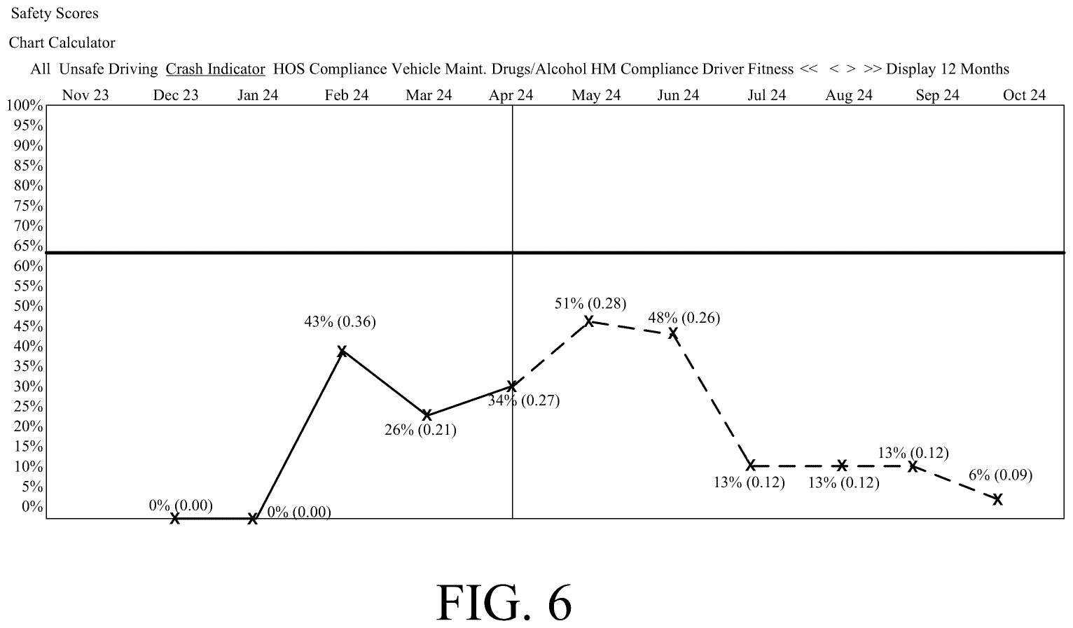

FIG. 6 is an example of an improved user interface showing 12 months of crash indicator safety scores with 6 months of actual data and 6 months of predicted data.

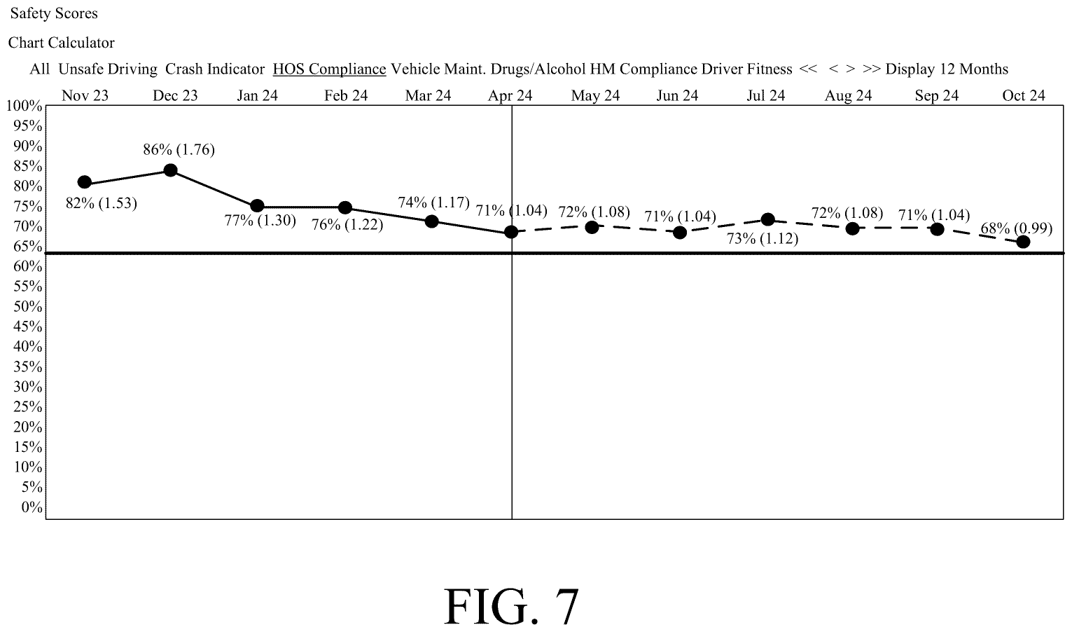

FIG. 7 is an example of an improved user interface showing 12 months of hours of service safety scores with 6 months of actual data and 6 months of predicted data.

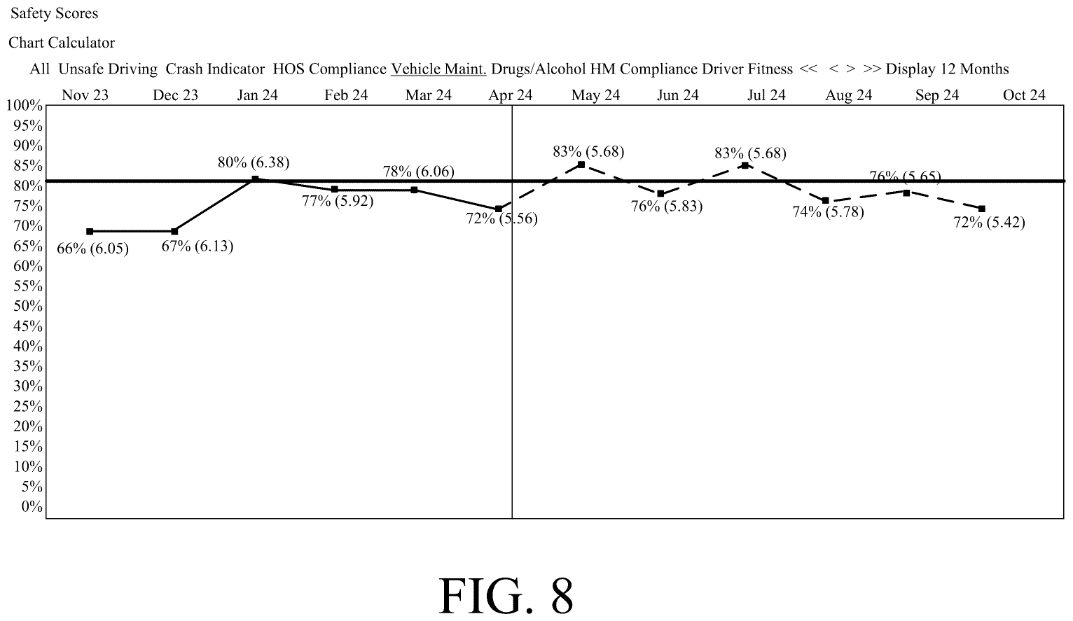

FIG. 8 is an example of an improved user interface showing 12 months of vehicle maintenance safety scores with 6 months of actual data and 6 months of predicted data.

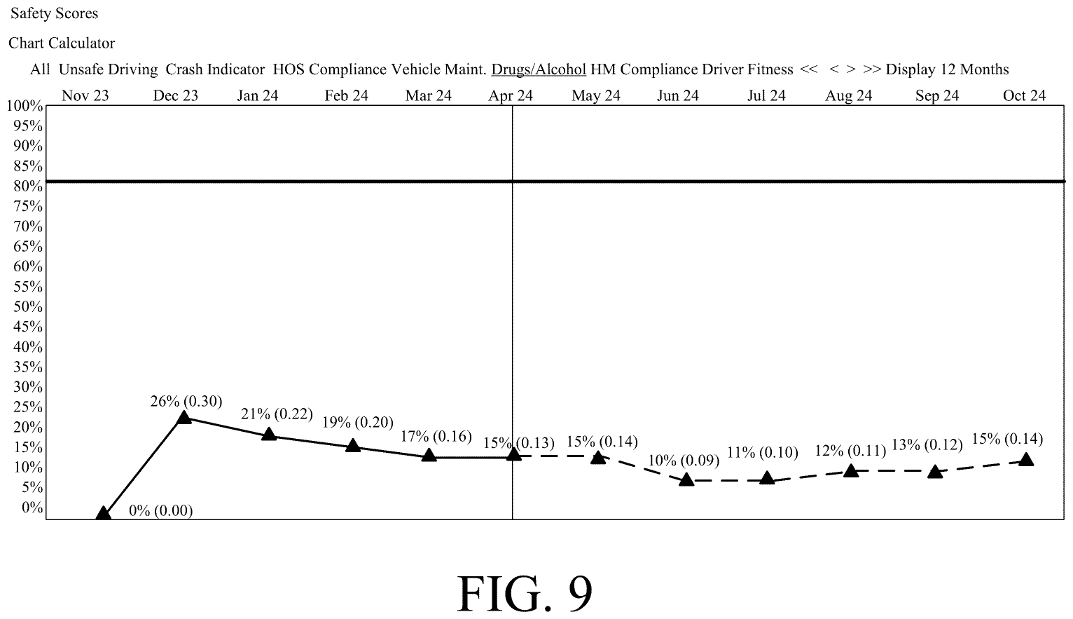

FIG. 9 is an example of an improved user interface showing 12 months of drug/alcohol safety scores with 6 months of actual data and 6 months of predicted data.

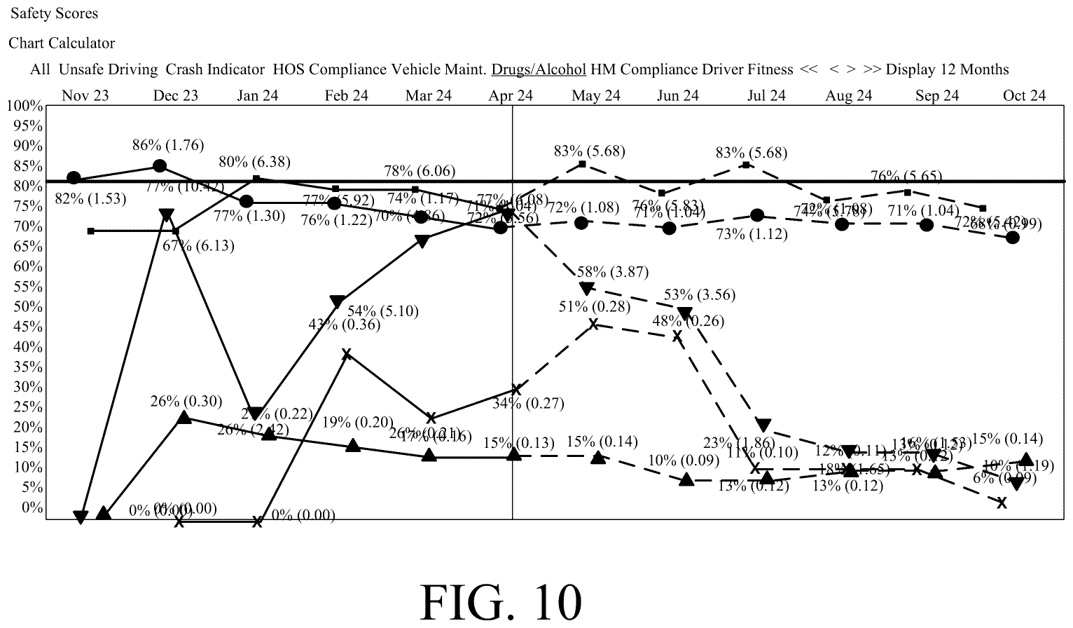

FIG. 10 is an example of an improved user interface showing 12 months of all seven FMCSA BASIC safety scores with 6 months of actual data and 6 months of predicted data.

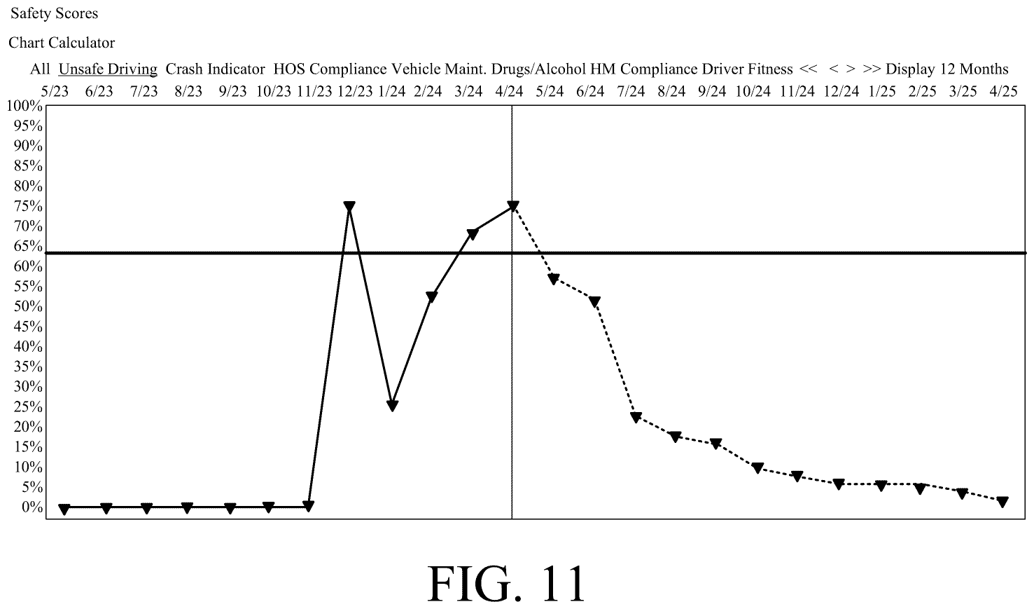

FIGS. 11-16 show versions of the improved user interface with 24 months of data selected.

FIG. 11 is an example of an improved user interface showing 24 months of a single BASIC—unsafe driving scores—with 12 months of actual data and 12 months of predicted data. Within the improved user interface of FIG. 11 (and the others discussed below), a user can click on (or select) a datapoint or measure within the interface and display additional details. In operation, a user can select one or more BASICs and can select a time range (e.g., 12 months or 24 months).

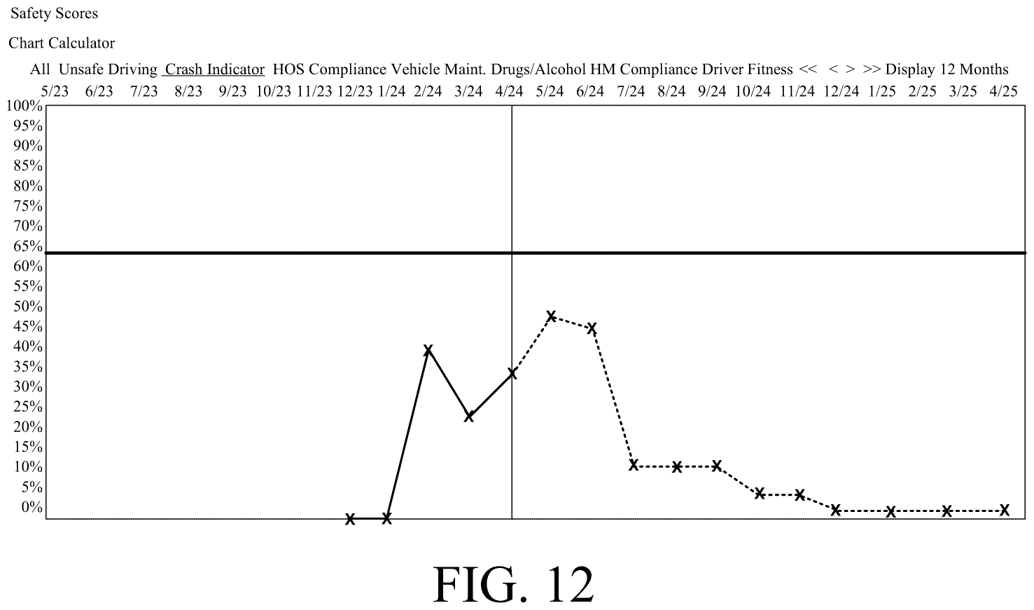

FIG. 12 is an example of an improved user interface showing 24 months of crash indicator safety scores with 6 months of actual data and 6 months of predicted data.

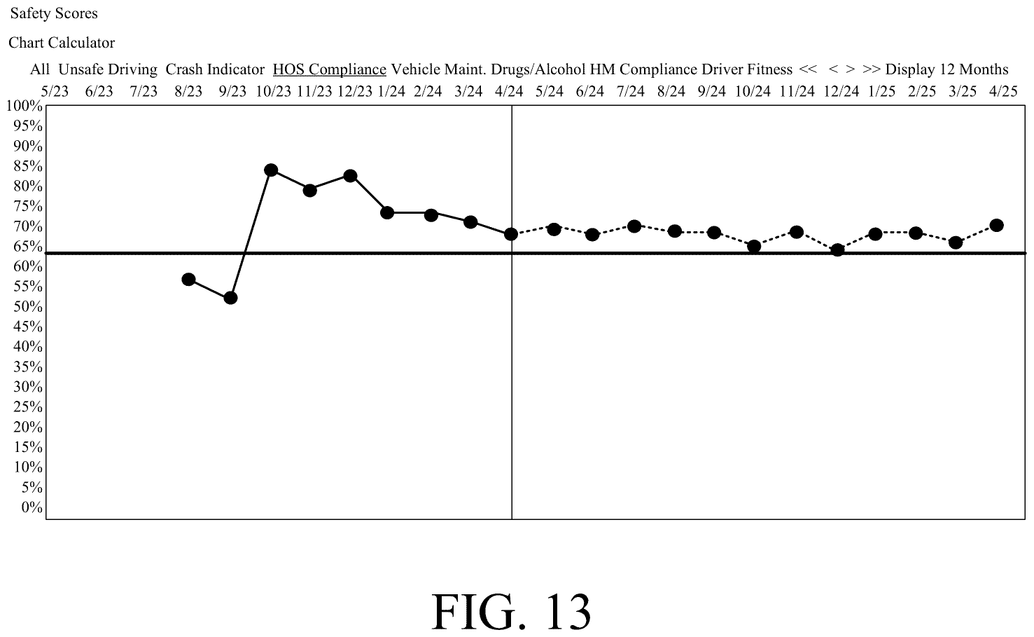

FIG. 13 is an example of an improved user interface showing 24 months of hours of service safety scores with 6 months of actual data and 6 months of predicted data.

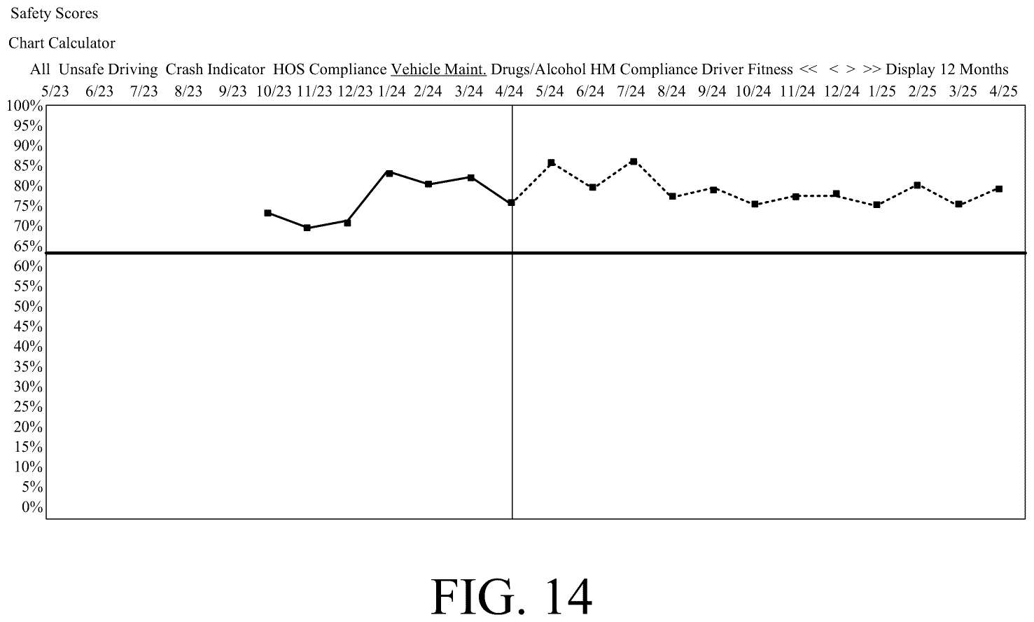

FIG. 14 is an example of an improved user interface showing 24 months of vehicle maintenance safety scores with 6 months of actual data and 6 months of predicted data.

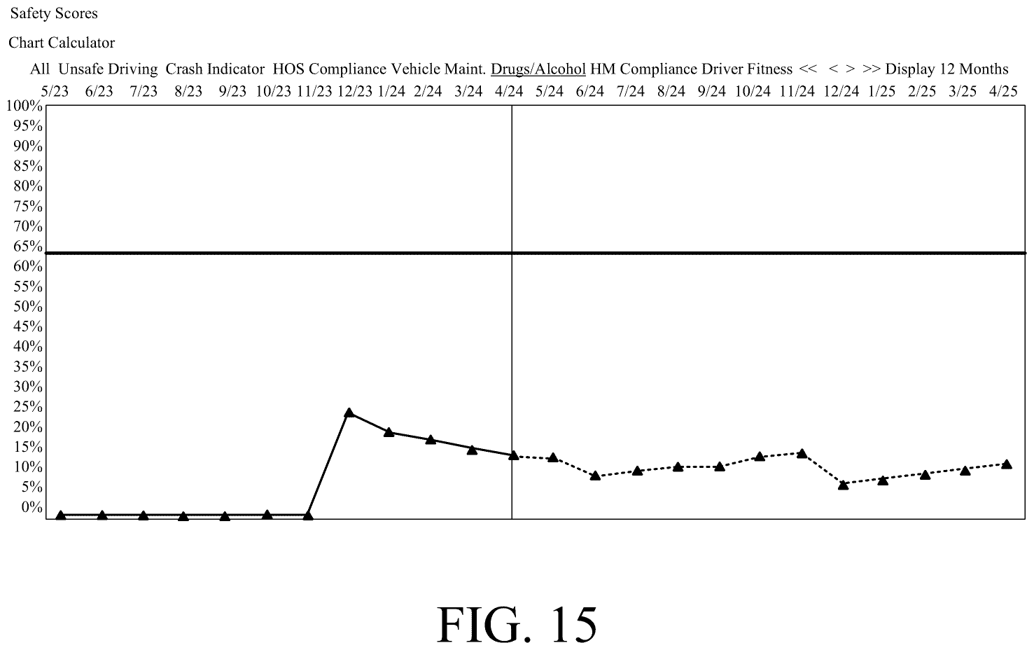

FIG. 15 is an example of an improved user interface showing 24 months of drug/alcohol safety scores with 6 months of actual data and 6 months of predicted data.

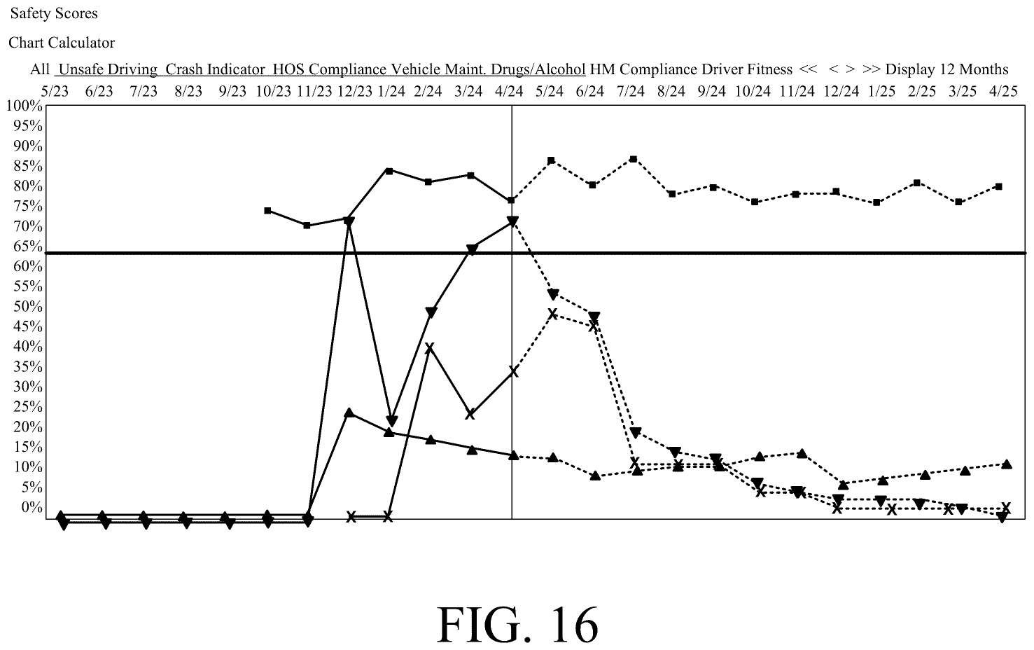

FIG. 16 is an example of an improved user interface showing 24 months of all seven FMCSA BASIC safety scores with 6 months of actual data and 6 months of predicted data.

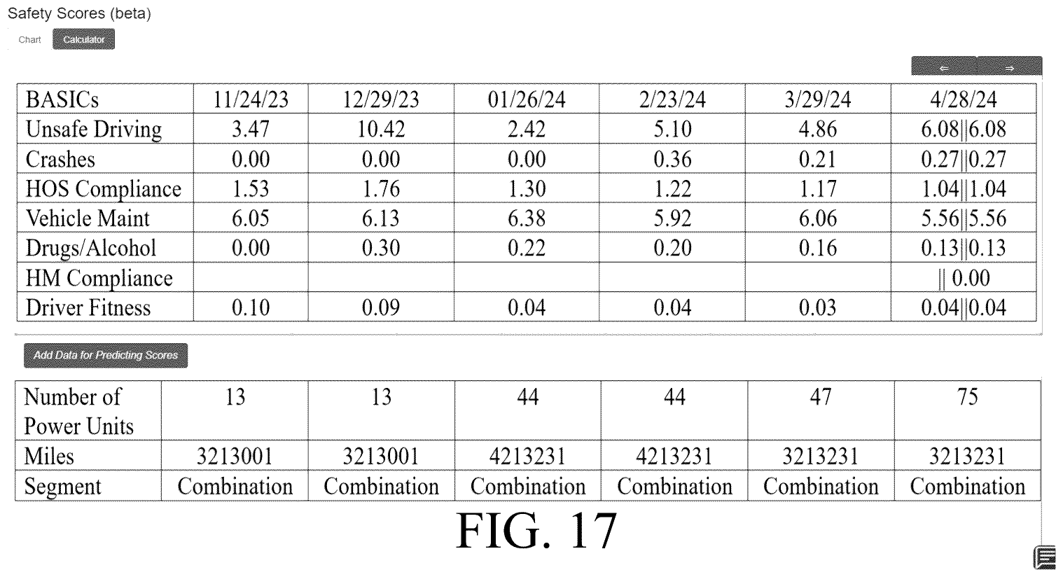

FIG. 17 is a diagram of an example safety score calculation history. The calculator history interface shows the calculated values for the seven BASICs for a plurality of dates. The example safety score calculation history user interface includes an element to add data for predicting scores.

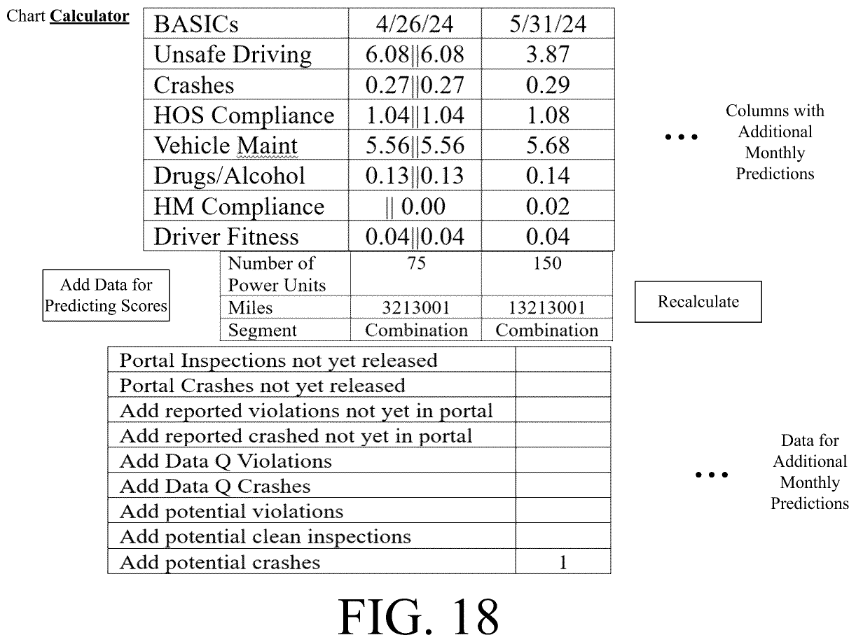

FIG. 18 is a diagram showing an example expanded safety score calculation interface in which the element for adding data for predicting scores was selected. Once the element for adding data is selected, the user interface expands from FIG. 17 to FIG. 18 and additional element to add specific values are displayed. The data for predicting scores can include one or more of number of power units, miles, segment, inspections not yet released, crashes not yet released, violations not yet in portal, crashes not yet in portal, data Q violations, data Q crashes, potential violations, potential clean inspections, and potential crashes. Once the additional data has been entered, the user can select the recalculate user interface element to cause the safety score predictions to recalculate based on the entered data.

FIG. 4 is a block diagram of an example device 400 which may be used to implement one or more features described herein. In one example, device 400 may be used to implement a client device, e.g., any of client devices 120-126 shown in FIG. 1. Alternatively, device 400 can implement a server device, e.g., server device 104, etc. In some implementations, device 400 may be used to implement a client device, a server device, or a combination of the above. Device 400 can be any suitable computer system, server, or other electronic or hardware device as described above.

One or more methods described herein (e.g., FIG. 3) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 400 includes a processor 402, a memory 404, and I/O interface 406. Processor 402 can be one or more processors and/or processing circuits to execute program code and control basic operations of the device 400. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 402 may include one or more co-processors that implement neural-network processing. In some implementations, processor 402 may be a processor that processes data to produce probabilistic output, e.g., the output produced by processor 402 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is typically provided in device 400 for access by the processor 402 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 402 and/or integrated therewith. Memory 404 can store software operating on the server device 400 by the processor 402, including an operating system 408, machine-learning application 430, motor carrier and driver safety score prediction application 410, and application data 412. Other applications may include applications such as a data display engine, web hosting engine, image display engine, notification engine, social networking engine, etc. In some implementations, the machine-learning application 430 and motor carrier and driver safety score prediction application 410 can each include instructions that enable processor 402 to perform functions described herein, e.g., some or all of the methods of FIG. 3.

The machine-learning application 430 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a motor carrier and driver safety score prediction application 410 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 430 may utilize Bayesian classifiers, support vector machines, neural networks, or other learning techniques. In some implementations, machine-learning application 430 may include a trained model 434, an inference engine 436, and data 432. In some implementations, data 432 may include training data, e.g., data used to generate trained model 434. For example, training data may include any type of data suitable for training a model for motor carrier and driver safety score prediction tasks, such as images, labels, thresholds, etc. associated with motor carrier and driver safety score prediction tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 434, training data may include such user data. In implementations where users permit use of their respective user data, data 432 may include permitted data.

In some implementations, data 432 may include collected data such as published and unpublished motor carrier and/or driver safety data. In some implementations, training data may include synthetic data generated for the purpose of training, such as data that is not based on user input or activity in the context that is being trained, e.g., data generated from simulated conversations, computer-generated images, etc. In some implementations, machine-learning application 430 excludes data 432. For example, in these implementations, the trained model 434 may be generated, e.g., on a different device, and be provided as part of machine-learning application 430. In various implementations, the trained model 434 may be provided as a data file that includes a model structure or form, and associated weights. Inference engine 436 may read the data file for trained model 434 and implement a neural network with node connectivity, layers, and weights based on the model structure or form specified in trained model 434.

Machine-learning application 430 also includes a trained model 434. In some implementations, the trained model 434 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 432 or application data 412. Such data can include, for example, images, e.g., when the trained model is used for motor carrier and driver safety score prediction functions. Subsequent intermediate layers may receive as input output of nodes of a previous layer per the connectivity specified in the model form or structure. These layers may also be referred to as hidden layers. A final layer (e.g., output layer) produces an output of the machine-learning application.

In different implementations, the trained model 434 can include a plurality of nodes, arranged into layers per model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 434 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 432, to produce a result.

For example, training may include applying supervised learning techniques. In supervised learning, the training data can include a plurality of inputs (e.g., a set of images) and a corresponding expected output for each input (e.g., one or more labels for each image representing aspects of a project corresponding to the images such as services or products needed or recommended). Based on a comparison of the output of the model with the expected output, values of the weights are automatically adjusted, e.g., in a manner that increases the probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner.

In another example, a model trained using unsupervised learning may cluster words based on the use of the words in data sources. In some implementations, unsupervised learning may be used to produce knowledge representations, e.g., that may be used by machine-learning application 430. In various implementations, a trained model includes a set of weights, or embeddings, corresponding to the model structure. In implementations where data 432 is omitted, machine-learning application 430 may include trained model 434 that is based on prior training, e.g., by a developer of the machine-learning application 430, by a third-party, etc. In some implementations, trained model 434 may include a set of weights that are fixed, e.g., downloaded from a server that provides the weights.

Machine-learning application 430 also includes an inference engine 436. Inference engine 436 is configured to apply the trained model 434 to data, such as application data 412, to provide an inference. In some implementations, inference engine 436 may include software code to be executed by processor 402. In some implementations, inference engine 436 may specify circuit configuration (e.g., for a programmable processor, for a field programmable gate array (FPGA), etc.) enabling processor 402 to apply the trained model. In some implementations, inference engine 436 may include software instructions, hardware instructions, or a combination. In some implementations, inference engine 436 may offer an application programming interface (API) that can be used by operating system 408 and/or motor carrier and driver safety score prediction application 410 to invoke inference engine 436, e.g., to apply trained model 434 to application data 412 to generate an inference.

Machine-learning application 430 may provide several technical advantages. For example, when trained model 434 is generated based on unsupervised learning, trained model 434 can be applied by inference engine 436 to produce knowledge representations (e.g., numeric representations) from input data, e.g., application data 412. For example, a model trained for motor carrier and driver safety score prediction tasks may produce predictions and confidences for given input information about safety scores. A model trained for motor carrier and driver safety score prediction tasks may produce a suggestion for one or more phases of a project, or a model for automatic estimating or evaluation of safety scores based on input safety data or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 436.

In some implementations, knowledge representations generated by machine-learning application 430 may be provided to a different device that conducts further processing, e.g., over a network. In such implementations, providing the knowledge representations rather than the images may provide a technical benefit, e.g., enable faster data transmission with reduced cost.

In some implementations, machine-learning application 430 may be implemented in an offline manner. In these implementations, trained model 434 may be generated in the first stage and provided as part of machine-learning application 430. In some implementations, machine-learning application 430 may be implemented in an online manner. For example, in such implementations, an application that invokes machine-learning application 430 (e.g., operating system 408, one or more of motor carrier and driver safety score prediction application 410 or other applications) may utilize an inference produced by machine-learning application 430, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 434, e.g., to update embeddings for trained model 434.

In some implementations, machine-learning application 430 may be implemented in a manner that can adapt to particular configuration of device 400 on which the machine-learning application 430 is executed. For example, machine-learning application 430 may determine a computational graph that utilizes available computational resources, e.g., processor 402. For example, if machine-learning application 430 is implemented as a distributed application on multiple devices, machine-learning application 430 may determine computations to be carried out on individual devices in a manner that optimizes computation. In another example, machine-learning application 430 may determine that processor 402 includes a GPU with a particular number of GPU cores (e.g., 1000) and implement the inference engine accordingly (e.g., as 1000 individual processes or threads).

In some implementations, machine-learning application 430 may implement an ensemble of trained models. For example, trained model 434 may include a plurality of trained models that are each applicable to the same input data. In these implementations, machine-learning application 430 may choose a particular trained model, e.g., based on available computational resources, success rate with prior inferences, etc. In some implementations, machine-learning application 430 may execute inference engine 436 such that a plurality of trained models is applied. In these implementations, machine-learning application 430 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 408 or one or more other applications, e.g., motor carrier and driver safety score prediction application 410.

In different implementations, machine-learning application 430 can produce different types of outputs. For example, machine-learning application 430 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 430 may produce an output video with a particular effect applied, e.g., rendered in a comic-book or particular artist's style, when trained model 434 is trained using training data from the comic book or particular artist, etc. In some implementations, machine-learning application 430 may produce an output based on a format specified by an invoking application, e.g., operating system 408 or one or more applications, e.g., motor carrier and driver safety score prediction application 410. In some implementations, an invoking application may be another machine-learning application. For example, such configurations may be used in generative adversarial networks, where an invoking machine-learning application is trained using output from machine-learning application 430 and vice-versa.

Any software in memory 404 can alternatively be stored on any other suitable storage location or computer-readable medium. In addition, memory 404 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the server device 400 with other systems and devices. Interfaced devices can be included as part of device 400 or can be separate and communicate with the device 400. For example, network communication devices, storage devices (e.g., memory and/or database 106), and input/output devices can communicate via I/O interface 406. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 406 can include one or more display devices 420 and one or more data stores 438 (as discussed above). The display devices 420 that can be used to display content, e.g., a user interface of an output application as described herein. Display device 420 can be connected to device 400 via local connections (e.g., display bus) and/or via networked connections and can be any suitable display device. Display device 420 can include any suitable display device such as an LCD, LED, or plasma display screen, CRT, television, monitor, touchscreen, 3-D display screen, or other visual display device. For example, display device 420 can be a flat display screen provided on a mobile device, multiple display screens provided in a goggles or headset device, or a monitor screen for a computer device.

The I/O interface 406 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 4 shows one block for each processor 402, memory 404, I/O interface 406, and software blocks 408, 410, and 430. These blocks may represent one or more processors or processing circuitries, operating systems, memories, I/O interfaces, applications, and/or software modules. In other implementations, device 400 may not have all of the components shown and/or may have other elements including other types of elements instead of, or in addition to, those shown herein. While some components are described as performing blocks and operations as described in some implementations herein, any suitable component or combination of components of environment 100, device 400, similar systems, or any suitable processor or processors associated with such a system, may perform the blocks and operations described.

In some implementations, the motor carrier and driver safety score prediction system could include a machine-learning model (as described herein) for tuning the system to potentially provide improved accuracy. Inputs to the machine learning model can include semantic information about motor carriers and driver safety score prediction. Example machine-learning model input can include labels for a simple implementation and can be augmented with descriptor vector features for a more advanced implementation. Output of the machine-learning module can include a prediction of safety score and/or percentile.

One or more methods described herein (e.g., method of FIG. 3) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
obtaining published data corresponding to one or more safety score categories;
applying a safety methodology to the published data to generate a published data score;
obtaining published data corresponding to the one or more safety score categories;
applying a safety methodology to the unpublished data to generate an unpublished data score;
combining the published data score and the unpublished data score; and
generating a percentile prediction from the combined published data score and unpublished data score.

2. The computer-implemented method of claim 1, further comprising:
obtaining simulated data corresponding to the one or more safety score categories.

3. The computer-implemented method of claim 2, further comprising:
generating a simulated percentile prediction based on the simulated data.

4. The computer-implemented method of claim 1, wherein the safety methodology includes the FMCSA SMS methodology.

5. The computer-implemented method of claim 1, wherein the one or more safety score categories include unsafe driving, crash indicator, hours of service compliance, vehicle maintenance, controlled substances and alcohol, hazardous materials compliance, and driver fitness.

6. The computer-implemented method of claim 1, further comprising:
causing to be displayed a safety score visualization user interface including:
elements for selecting one or more of the safety score categories;
a graphical display element having a portion showing an actual safety score value corresponding to a selected one or more of the safety score categories and a portion showing a predicted safety score value corresponding to the selected one or more of the safety score categories; and
an element for selecting a time period for displaying the actual safety score and the predicted safety score.

7. The computer-implemented method of claim 2, wherein:
obtaining simulated data corresponding to the one or more safety score categories includes:
displaying a safety score user interface configured to accept one or more simulated data values and an element to recalculate safety scores; and
when the element to recalculate safety scores is selected, causing the predicted safety scores to be recalculated based on the one or more simulated data values.
